(19) United States
(12) Patent Application Publication
(10) Pub. No.: US 2026/0162528 A1
(43) Pub. Date: Jun. 11, 2026

(54) METHOD AND SYSTEM FOR DRONE-GUIDED TRAFFIC ASSISTANCE

(71) Applicant: ACCENTURE GLOBAL SOLUTIONS LIMITED, Dublin (IE)

(72) Inventors: Amit KUMAR, Summit, NJ (US); Nishant MEHTA, Livingston, NJ (US); Piyush MANOCHA, Faridabad (IN); Anshul GUPTA, Delhi (IN); Dharmesh KUMAR, Bangalore (IN); Meet Kalpesh BHALAVAT, Mumbai (IN); Saurabh GARG, Gurugram (IN); Bhawana PAL, Farrukhabad (IN)

(73) Assignee: ACCENTURE GLOBAL SOLUTIONS LIMITED, Dublin (IE)

(21) Appl. No.: 19/407,787

(22) Filed: Dec. 3, 2025

(30) Foreign Application Priority Data
Dec. 11, 2024 (IN) 202441098044

(51) Int. Cl. G08G 1/09; B64U 20/80; B64U 101/30; E21F 17/18; G08G 1/01

(52) U.S. Cl. CPC G08G 1/09; B64U 20/80; E21F 17/18; G08G 1/012; G08G 1/0125; B64U 2101/30

(57) ABSTRACT

Method, system, and computer-readable storage media for drone-guided traffic assistance are disclosed. Real-time drone data is received from one or more drones. Also, fleet management system data of a fleet comprising a plurality of vehicles is received. Based on the real-time drone data and the fleet management system data, a priority of the plurality of vehicles, which include at least two vehicles in transit, is determined. Based on the real-time drone data and the fleet management system data, it is determined whether a first vehicle of the plurality of vehicles should be approved to continue driving. If approved, driving instructions corresponding to the first vehicle are transmitted to the first vehicle. If not, a second vehicle of the plurality of vehicles that should have a priority over the first vehicle to continue driving is determined. Driving instructions corresponding to the second vehicle are then transmitted to the second vehicle.

### TECHNICAL FIELD

Various examples described herein relate generally to a method, system, and computer-readable storage media for drone-guided traffic assistance.

### BACKGROUND

Mining operations typically involve transportation of materials, equipment, and personnel across expansive and often rugged terrains. The mining operations require coordination of various types of heavy equipment, such as haul trucks and excavators, and support vehicles. The increasing scale of mining operations, coupled with the need for efficiency and safety, has made effective traffic management a critical concern.

### SUMMARY

Implementations of the present disclosure provide real-time traffic assistance by using real-time drone-based movement information, terrain and location data along with site map data, vehicle and equipment schedule data, and on-board vehicle sensor data.

In at least one example, the present disclosure provides a computer implemented method for drone-guided traffic assistance. The method may include receiving real-time drone data from one or more drones of a plurality of drones. The method may further include receiving fleet management system data of a fleet comprising a plurality of vehicles. Based on the real-time drone data and the fleet management system data, the method may include determining a respective priority of the plurality of vehicles, which include two or more vehicles in transit. Based on the real-time drone data and the fleet management system data, the method may include determining whether a first vehicle of the plurality of vehicles should be approved to continue driving. Based upon determining that the first vehicle should be approved to continue driving, the method may include transmitting to the first vehicle, driving instructions corresponding to the first vehicle. Further, based upon determining that the first vehicle should not be approved to continue driving, the method may include determining a second vehicle of the plurality of vehicles that should have a priority over the first vehicle to continue driving. The method may then include transmitting, to the second vehicle, driving instructions corresponding to the second vehicle.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE FIGURES

Various examples in accordance with the present disclosure will be described with reference to the drawings, in which:

FIG. 1 depicts an example environment that may be used to execute implementations of the present disclosure.

FIG. 2 depicts an example process flow performed by an action control module of FIG. 1, in accordance with implementations of the present disclosure.

FIG. 3 is a flow diagram that presents an example method for drone-guided traffic assistance, in accordance with implementations of the present disclosure.

FIG. 4 depicts a computer system that may be used to implement drone-guided mine adaptive traffic assistance system of FIG. 1, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” and the like are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, and the like).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

“Vehicles” and the like may refer to autonomous vehicles or manual vehicles with advanced driver assist systems.

Mining operations often requires substantial movement of heavy equipment, vehicles, and personnel. The complexity of the mining operations is heightened by a need to coordinate numerous activities in potentially hazardous environments. For example, an interaction between the heavy equipment and personnel poses significant safety hazards, with accidents resulting from poor visibility, miscommunication, and inadequate traffic controls. Also, on-surface movement of the heavy equipment and vehicles for the mining operations is challenging due to difficult terrains, steep curves, varying road dimensions and conditions, and ever-changing situations. Therefore, traffic management in mining sites during the mining operations according to embodiments described herein may reduce the safety hazards and effectively decide movement of the heavy equipment and the vehicles.

Traditionally, traffic management in the mining sites relies on manual oversight, static signage, and predetermined routes. Operators use visual cues and communications among team members to manage movement of the heavy equipment and the vehicles (hereinafter collectively referenced to as a vehicle). However, these methods often fall short in several critical areas leading to significant safety hazards, congestion, delays in operations, and increased operational costs. Also, static traffic plans generated by the operators do not adapt to evolving site conditions, leading to missed opportunities for optimizing traffic flow.

For the traffic management during the mining operations, existing techniques use on-vehicle mounted sensors on the heavy equipment used in the mining sites. The on-vehicle mounted sensors have short range (e.g., a line of sight) and can help avoid in-range collisions. However, the on-vehicle mounted sensors cannot predict or avoid blockages and collisions as there is no oversight of a system which combines multiple on-vehicle mounted sensors and real time position related information to predict blockages and collisions.

Further, the existing techniques of drone usage are generally restricted to creation of three-dimensional (3D) maps and haulage road designs for on-surface mining or autonomous navigation of drone itself in underground mining. The 3D maps are created periodically to identify changes in terrain with limited details. Some of the critical details such us road width, slope, blockages and the like are not captured which are critical during the movement on the road. Therefore, the operation of large vehicles in proximity can lead to accidents, resulting in injuries to personnel and damage to equipment. Therefore, the existing techniques often lack the real-time responsiveness required to mitigate these risks effectively.

Implementations of the present disclosure use real-time drone data and other multiple systems to optimize and forecast decision of vehicles on the mining sites and suggest driving instructions to the vehicles to avoid blockages and/or obstacles. The present disclosure uses Artificial intelligence (AI) or machine learning (ML) models to compute the driving instructions, such as vehicle speed, lanes and other driving patterns to optimize traffic and movement of the vehicle in on-surface mines. In an example, based on the real-time drone data and fleet management system data, a respective priority of vehicles, which include two or more vehicles in transit. Based on the real-time drone data and the fleet management system data, it is determined whether a first vehicle of the plurality of vehicles should be approved to continue driving with the same set of variables not limited to speed, direction, lane change and the like. If the first vehicle is approved to continue driving, driving instructions corresponding to the first vehicle are transmitted to the first vehicle. If the first vehicle is not approved to continue driving, a second vehicle of the plurality of vehicles that should have a priority over the first vehicle is determined and/or approved to continue driving. Driving instructions corresponding to the second vehicle are then transmitted to the second vehicle.

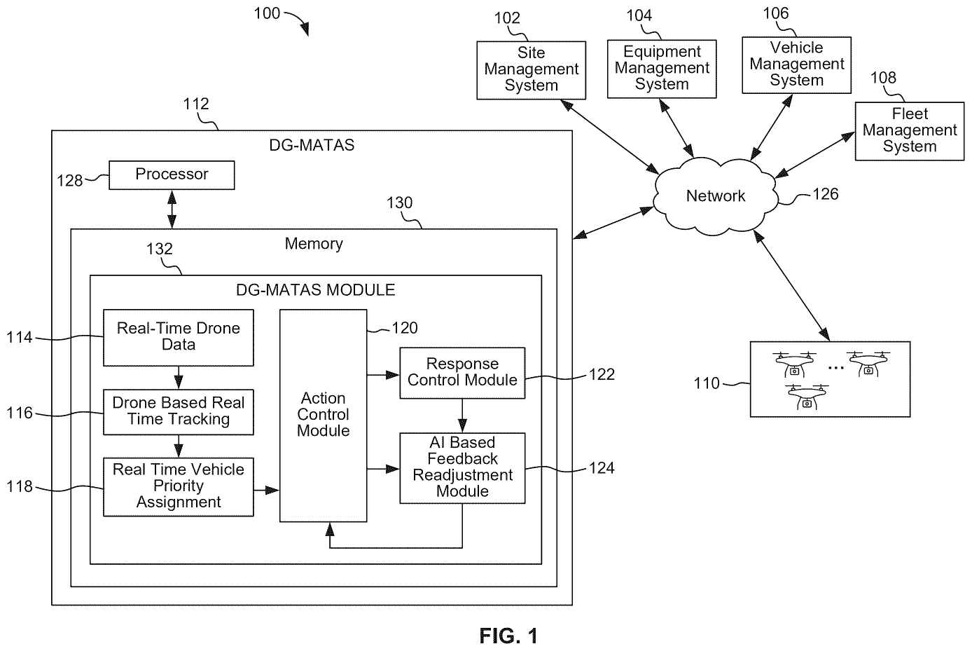

FIG. 1 depicts an example environment that may be used to execute implementations of the present disclosure. The example environment 100, shown in FIG. 1, includes a site management system 102, an equipment management system 104, a vehicle management system 106, a fleet management system 108, a plurality of drones 110, and a drone guided-mine adaptive traffic assistance system (DG-MATAS) 112 (hereinafter referenced to as a system 112). For example, the plurality of drones 110 may be airborne drones that include one or more image sensors. The site management system 102, the equipment management system 104, the vehicle management system 106, the fleet management system 108, the plurality of drones 110, and the system 112 may communicate with each other using a network 126. In some examples, the network 126 may include a Local Area Network (LAN), a Wide Area Network (WAN), the Internet, or a combination thereof. In some examples, the network 126 may be accessed over a wired and/or a wireless communication link.

In an example, the site management system 102 receives site management information, such as haulage road designs, shift details, drop sites, work sites, material type, road conditions and the like. Further, the site management system 102 performs trip planning, productivity planning, and material prioritization required to perform a mining operation using the received site management information.

Further, in an example, the equipment management system 104 receives equipment management information, such as an equipment list, equipment history usage, maintenance plan and history, load cycle time, work sites, bucket payload capacity of equipment, and the like. For example, let H be a function such that for each equipment Eᵢ available for the mining operation, the function returns an equipment that can be considered fit for operation. For example,

$$H ( {E}_{i} ) = \{ {E}_{i} , ( {E}_{f o i} , {E}_{fdi} , {E}_{f m i} , {E}_{a i} ) \}$$

where,
E_{foi}={0,1}, where i=1,2,3 . . . n, if onboard sensors of the equipment are functional and relays measurement results,
E_{foi}=1 if the onboard sensors are functional,
E_{foi}=0 if the onboard sensors are non-functional,
E_{fdi}={0,1}, where i=1,2,3 . . . n, if the onboard sensors are online and communicate back and forth with the plurality of drones 110 and the site management system 102,
E_{fdi}=1 if the onboard sensors are online,
E_{fdi}=0 if the onboard sensors are offline,
E_{fmi}={0,1}, where i=1,2,3 . . . n, if the equipment is not due for maintenance in less than, for example, 12 hours which ensure current shift hours operation without any breakdown,
E_{fmi}=0 if the equipment is due for maintenance,
E_{fmi}=1 if the equipment is not due for maintenance,
Eₐᵢ={0,1}, where i=1,2,3 . . . n, if a vehicle average wait time at the equipment exceeds acceptable limit and can cause congestion,
Eₐᵢ=0 if (Σᵢ(V_{1wti})/n)>2*Tᵢⱼₖ, and
Eₐᵢ=1 if (Σᵢ(V_{1wti})/n)<2*Tᵢⱼₖ,
where, each vehicle wait time to get loaded be V_{1wti}, then average can be defined as (Σᵢ(V_{1wti})/n),
n is a number of Vehicles and
Tᵢⱼₖ be an average time taken by a vehicle Vᵢ, where (i=1, 2, . . . ,n) to travel on a route Rₜⱼₖ.

In this example, if either of E_{foi}, E_{fdi}, E_{fmi}, Eₐᵢ is a null value, then the function moves to a next equipment check. If the factors E_{foi}, E_{fdi}, E_{fmi}, Eₐᵢ is a unity value, then the function add the respective equipment into a fit equipment list and moves to the next equipment check. Further, the equipment management system 104 determines fitness of each equipment in the equipment list and sort equipment's in the equipment list based on an equipment usage ratio. For example, R(H(Eᵢ)) is a function such that for each vehicle Vᵢ available for the mining operations, the function returns the equipment's in order to prioritize that has the equipment usage ratio less than or equal to 85% and maintenance greater than or equal to 1 day.

Furthermore, in an example, the vehicle management system 106 receives vehicle management information, such as a vehicle list, vehicle history usage, maintenance plan and history, unload cycle time, vehicle dimensions, vehicle payload capacity, vehicle weight with load, and the like. Further, the vehicle management system 106 determines fitness of the plurality of vehicles in the vehicle list using the received vehicle management information. For example, F is a function such that for each vehicle Vᵢ available for a mining operation, the function F returns the vehicle that can be considered fit for the mining operation.

$$F ( {V}_{i} ) = \{ {V}_{i} , ( {V}_{f o i} , {V}_{fdi} , {V}_{f m i} ) \}$$

where,
V_{foi}={0,1}, where i=1,2,3 . . . n, if onboard sensors of the vehicle are functional and relays on measurement results,
V_{foi}=1, if the onboard sensors are functional,
V_{foi}=0, if the onboard sensors are non-functional,
V_{fdi}={0,1}, where i=1,2,3 . . . n, if the onboard sensors are online and communicate back and forth with the plurality of drones 110 and the site management system 102,
V_{fdi}=1, if the onboard sensors are online,
V_{fdi}=0, if the onboard sensors are offline,
V_{fmi}={0,1}, where i=1,2,3 . . . n, if the vehicle is not due for maintenance in less than 12 hours which ensure current shift hours operation without any breakdown,
V_{fmi}=0, if the vehicle is due for maintenance, and
V_{fmi}=1, if the vehicle is not due for maintenance.

In this example, if either of V_{foi}, V_{fdi}, V_{fmi} is a null value, the function moves to a next vehicle check. If all of factors V_{foi}, V_{fdi}, V_{fmi} is a unity value, the function adds the vehicle into a fit vehicle list and moves to the next vehicle check. Further, the vehicle management system 106 determine fitness of each vehicle in the vehicle list and sort the plurality of vehicles based on a vehicle use ratio. For example, let S(F(Vᵢ)) be a function such that for each vehicle Vᵢ available for the mining operation, the function returns the vehicles in order to prioritize that has the vehicle usage ratio less than or equal to 85% and maintenance greater than or equal to 1 day.

In an example, the fleet management system 108 receives output of the vehicle management system 106, the equipment management system 104, and the site management system 102 to prioritize and create an optimal planned trip schedule for a day including a vehicle, equipment, material, and route mapping. The fleet management system 108 generates fleet management data of a fleet including the plurality of vehicles. The fleet management data may include route information for each vehicle of the plurality of vehicles, a type of payload being carried by each vehicle of the plurality of vehicles, and/or a schedule for each vehicle of the plurality of vehicles. For example, let VM_{f} be a function such that for a first assignment of the day, each fit vehicle available gets mapped to each fit equipment available at respective work site to pick a material assigned. In this example, a fit vehicle V₁ assigned to a fit equipment E₁ to pick a material M₁ in a shift Sh₁ from a work site WS₁ to a drop site DP₁ i.e.,

$$V {M}_{f} ( s {h}_{p} , ( M ( {m}_{j} ) , {WS}_{k} , {DP}_{l} , S ( F ( {V}_{i} ) ) , R ( H ( {E}_{k} ) ) ) ) = V {M}_{f 1}$$

i.e., (Sh₁, m₁, WS₁, DP₁, V₁, E₁): V₁ϵF(Vᵢ), m₁ϵmⱼ, Sh₁ϵshₚ, WS₁ϵWSₖ, DP₁ϵDPₗ, where (i, j, k, l, p=1,2 . . . n).
   In this example, if there are no fit vehicles or equipment, the function VM_{f} returns a null value. Initially, F(Vᵢ) includes fit vehicles and after each assignment, that vehicle may no longer be part of an available vehicle set until the vehicles reaches the drop site. Also, assignments may ensure for possible assignments (VM_{f1}, VM_{f2}, . . . VM_{f3}) such that:

$$\begin{matrix}\sum ( {C}_{tv} , {C}_{t E} ) / {sh}_{d} \approx 1 \\ {P}_{r} / {P}_{d} \approx 1\end{matrix}$$

where,
Cₜᵥ is an average cycle time for a vehicle to transport a material between a work site and a drop point,
C_{tE} is a cycle time for an equipment to load the material at the work site,
P_{d} is a daily productivity target, and
Pᵣ is daily productivity assigned to the fleet of vehicles.

The system 112 may include a processor 128 and a memory 130. Further, the memory 130 may include a DG-MATAS module 132. In an example, the DG-MATAS module 132 may include an action control module 120, a response control module 122, and Artificial Intelligence (AI) based feedback readjustment module 124, which may be communicatively coupled to each other. The processor 128 may include one or more processors. Examples of the one or more processors may include, but not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the processor 128 may be programmed to execute computer-readable instructions stored in the memory 130 (also referenced herein as computer-readable storage medium (CRM)) for performing operations according to the present disclosure. The memory 130 may be non-transitory or non-volatile medium, such as a magnetic disk or solid-state non-volatile memory or volatile medium such as Random Access Memory (RAM), and/or the like.

In an example, the system 112 may receive real-time drone data 114 (e.g., continuous data) from one or more drones (e.g., airborne drones) of the plurality of drones 110 and the fleet management system data from the fleet management system 108. The real-time drone data may be based on one or more image sensors positioned at the one or more drones of the plurality of drones. For example, the one or more image sensors may capture real-time image data from the mining site. In this example, the real-time image drone data 114 is analyzed to determine the real-time drone data that includes elevation information of a route of each vehicle of the plurality of vehicles, vehicle location information within a predetermined proximity threshold information for each vehicle of the plurality of vehicles, and/or payload data information of each vehicle of the plurality of vehicles. Further, the system 112 may provide drone-guided traffic assistance using the received real-time drone data 114, which is described in detail below along with the DG-MATAS module 132, and the action module 120

For example, the DG-MATAS module 132 may perform drone based real-time tracking 116 to determine elevation information, proximity information, and a vehicle with or without payload information, using the real-time drone data 114 and the fleet management system data. Furthermore, the DG-MATAS module 132 may perform real-time vehicle priority assignment 118 using the real-time drone data 114, the fleet management system data, the elevation information, the proximity information and the vehicle with or without payload information. In an example, the DG-MATAS module 132 may determine a respective priority of the plurality of vehicles, which include two or more vehicles in transit.

In an example, let a priority of a vehicle be: P=(((PX/e)∩wⱼ)∩elₖ)

where,
j=1, 2, 3 . . . n,
k=1, 2, 3 and k is a function that includes vehicles in transit and in proximity and assigns a highest priority vehicle to a set P₁ and a lowest priority vehicle to a set Pₙ,
PX be a set of vehicles that are in proximity of each other within a distance±d,
wⱼ be a set of vehicles in transit with payload,
e be a set of vehicles in transit with no payload, and
el be a set that contains elevation details such as uphill, downhill, flat in subsets.
   In this example, if a set of two vehicles have same priority assigned, respective total weight is compared and prioritized accordingly. The vehicle with more weight may be given high priority than the vehicle with less weight.

The action control module 120 determines whether a first vehicle (e.g., a vehicle with highest priority) of the plurality of vehicles should be approved to continue driving based on the real-time drone data 114 and the fleet management system data. In an example, the action control module 120 determines whether the first vehicle is at least a safe threshold distance away from one or more vehicles of the plurality of vehicles. Further, the action control module 120 determines whether the first vehicle is at least a safe edge distance away.

Also, the action control module 120 transmits, to the first vehicle, driving instructions corresponding to the first vehicle, based upon determining that the first vehicle should be approved to continue driving. In an example, the action control module 120 transmits, to the first vehicle, the driving instructions corresponding to the first vehicle to continue driving based upon determining that the first vehicle is at least the safe threshold distance away from one or more vehicles of the plurality of vehicles and based upon determining that the first vehicle is at least the safe edge distance away. In another example, the action control module 120 transmits, to the first vehicle, the driving instructions corresponding to the first vehicle to change a driving lane and continue driving in a new driving lane if a leeway distance is at least greater than the safe threshold distance based upon determining that the first vehicle is at least the safe threshold distance away from one or more vehicles of the plurality of vehicles and based upon determining that the first vehicle is not at least the safe edge distance away. In yet another example, the action control module 120 transmits, to the first vehicle, the driving instructions corresponding to the first vehicle to change a driving lane and continue driving in a new driving lane if a leeway distance is at least greater than the safe edge distance based upon determining that the first vehicle is not at least the safe threshold distance away from one or more vehicles of the plurality of vehicles and based upon determining that the first vehicle is at least the safe edge distance away. In another example, the action control module 120 transmits, to the first vehicle, the driving instructions corresponding to the first vehicle to stop to determine whether the one or more vehicles of the plurality of vehicles should be prioritized for driving instead of the first vehicle based upon determining that the first vehicle is not at least the safe threshold distance away from one or more vehicles of the plurality of vehicles and based upon determining that the first vehicle is not at least the safe edge distance away. For example, the driving instructions corresponding to the first vehicle to stop is further transmitted based upon a road width and traffic congestion on a route of the first vehicle.

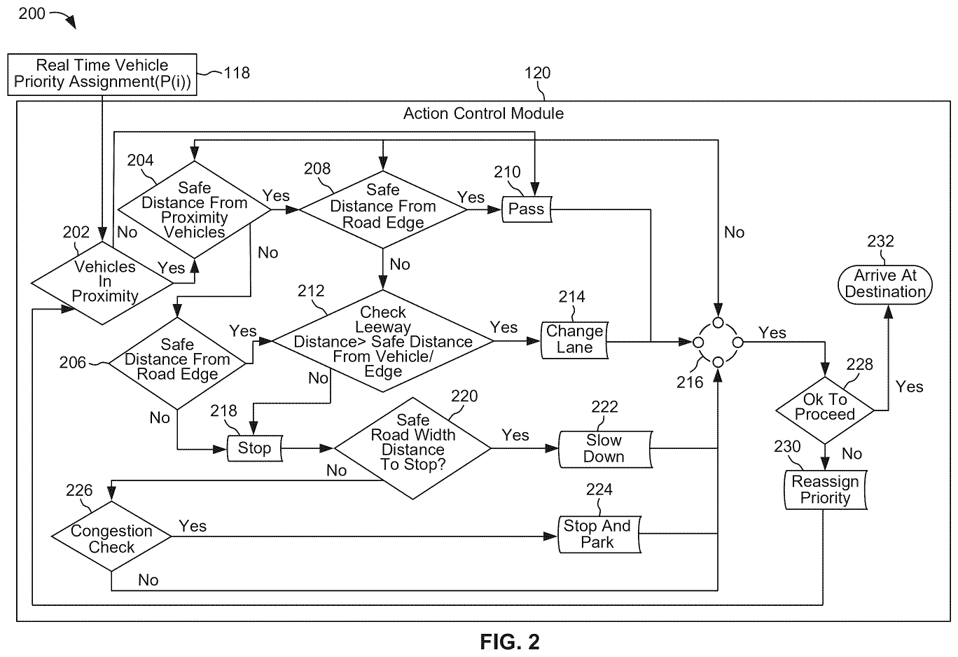

In addition, the action control module 120 may determine, based upon determining that the first vehicle should not be approved to continue driving, a second vehicle of the plurality of vehicles that should have a priority over the first vehicle to continue driving. Also, the action control module 120 may transmit, to the second vehicle, driving instructions corresponding to the second vehicle. The above process flow performed by the action control module 120 is explained in detail with reference to FIG. 2.

Further, the response control module 122 may store the driving instructions provided by the action control module 120, actual decisions taken by a driver of the vehicle in real-time, and outcome of the actual decisions, such as whether the vehicle is in a correct driving lane without causing any fluctuation in traffic volume or whether the vehicle is causing fluctuation in the traffic volume.

The AI based feedback readjustment module 124 may provide feedback to action control module 120 for improving accuracy of the driving instructions. In some examples, the AI based feedback readjustment module 124 may use an AI model for generating feedback. The AI based feedback readjustment module 124 may train the AI model using a compliance factor, a road condition factor, a frequency factor, and a recency factor. For example, the compliance factor (μᵢⱼₖ) of generated decisions may improve decision making by creating a leeway for a vehicle Vᵢ on road stretch of a route (Rt(Q)ᵢⱼ). In this example, the leeway enables adjustments in traffic signals, speed limits, or lane allocations in a way that accommodates unpredictable factors such as accidents, weather, roadwork, and fluctuations in the traffic volume.

The trained AI model may then be used to track actual parameters like costs, duration, productivity, compliance, and the like associated with the driving instructions and correlate the driving instructions vs the actual decisions to evaluate effectiveness of the driving instructions. Also, the outcome of the tracking and correlation may be generated as the feedback to the action control module 120 to improve accuracy of the driving instructions. Thus, making the system 112 intelligent and highly efficient. While implementations of the present disclosure are described in further detail herein with non-limiting reference to the AI model, it is contemplated that implementations of the present disclosure may be realized using any appropriate foundation models or Large Language Models (LLMs) or Machine Learning (ML) models.

For example, the road condition factor (ζᵢⱼₖ) which varies based on the road usage and weather condition changes is determined as:

$${ζ}_{i j k} = ( {\sum }_{i = 1}^{n} {\sum }_{j = 1}^{n} {\sum }_{k = 1}^{n} ( ( {ρ}_{w} * ρ * {δ}_{i j k} ) + ( {ω}_{w} * ω * {δ}_{i j k} ) ) )$$

where,
δᵢⱼₖ be a ratio of extra/less distance travelled by a vehicle Vᵢ after system generated driving instruction on route Rtⱼₖ where (i=1,2 . . . n) on a particular trip,
ω be the frequency factor of delays such that 0<ω<1 in the particular trip,
ρ be the recency factor of the delays such that 0<ρ<1 in the particular trip,
ω_{w} be a weightage assigned to the frequency factor, and
ρ_{w} be a weightage assigned to the recency factor.

To generate effective driving instructions and self-heal, the AI based feedback readjustment module 124 stores generated driving instruction in a set represented as GD, an actual decision in a set represented as AD, and an outcome in a set represented as OT against every driving instruction.

$${μ}_{i j k X} , {μ}_{i j k Y} = {\sum }_{i = 1}^{n} {\sum }_{j = 1}^{n} {\sum }_{k = 1}^{n} ( ( k * {k}_{w} * ( ( G {D}_{i j k} + A {D}_{i j k} + {OT}_{i j k} ) / 3 n ) ) + ( △ * {△}_{w} * ( ( G {D}_{i j k} + A {D}_{i j k} + {OT}_{i j k} ) / 3 n ) ) )$$

where,
k be the frequency factor of the delays such that 0<k<1 on the particular day,
Δ be the recency factor of the delays such that 0<Δ<1 on the particular day,
k_{w} be the weightage assigned to the frequency factor,
Δ_{w} be the weightage assigned to the recency factor, and
μ_{ijkX}, μ_{ijkY} be respective factors to consider a safe distance based on daily road uses and driving controls.

FIG. 2 depicts an example process flow 200 performed by the action control module 120 of FIG. 1, in accordance with implementations of the present disclosure. In an example, the action control module 120 may identify the first vehicle with a first priority and the second vehicle with a second priority from the real-time vehicle priority assignment data 118 (described in FIG. 1). Further, the action control module 120 may determine 202 whether one or more vehicles are in proximity of the first vehicle or the second vehicle. When it has been determined that the one or more vehicles are not in proximity of the first vehicle or the second vehicle, the action control module 120 may pass 210 the first vehicle by transmitting driving instructions of no change in the driving lane or direction.

When it has been determined that the one or more vehicles are in proximity of the first vehicle or the second vehicle, the action control module 120 may determine 204 whether the first vehicle is at a safe distance from the one or more vehicles that are in proximity. For example, μ_{ijkY}*SE_{dY} and μ_{ijkX}*SE_{dX} be safe distances from side-side and front-back on a particular obstacles/road edge. Further, let D is a function which returns distances from approaching vehicles from front, back or sides in X (front-back) and Y (side-side) for respective proximity vehicles. If Vᵢ is being approached by V_{α} from left, V_{β} from back, and V_{λ} from right, then D(PX(Vᵢ±d)) may output X component of proximity vehicles as D_{X}{X_{iαLX}, X_{iβB}, X_{jλR}} and Y component of the proximity vehicles as D_{Y}{Y_{iαL}, Y_{iβB}, Y_{jλR}}, where L denotes left, R denoted right, B denotes back and the proximity vehicles is a dynamic set and keeps changing based on a movement of the respective vehicle.

If the first vehicle is at the safe distance from the one or more vehicles that are in proximity, the action control module 120 may determine 208 whether the first vehicle is at a safe distance from a road edge. If the first vehicle is at the safe distance from the road edge or if there are no vehicles in the proximity, the action control module 120 may pass 210 the first vehicle by transmitting driving instructions of no change in the driving lane or direction.

If the first vehicle is not at the safe distance from the one or more vehicles that are in proximity or the one or more vehicles are in proximity of the second vehicle, the action control module 120 may determine 206 whether the second vehicle is at the safe distance from the road edge. For example, let Qᵢⱼ be a set that has data of road width on route Rtᵢⱼ, then Qᵢⱼ (width(w), road stretch(rs))=(Q_{ijw}, Qᵢⱼᵣₛ)=((15 m,1 m), (15.3 m, 1 m), . . . ) based on an airborne drone. Further, let U_{XY} be a function that return distances in X (front-back), Y (side-side) from road edges and vehicle edge when the vehicles are in proximity. In this example, U_{XY}(PX(Vᵢ), ±d) may output X component of the proximity vehicles as U_{X}{(X_{FE1}, X_{BE1}), (X_{FE2}, X_{BE2}), . . . } and output Y component of the proximity vehicles U_{Y}{(Y_{LE1}, Y_{RE1}), (Y_{LE2}, Y_{RE2}), . . . }.

If the first vehicle is not at the safe distance from the road edge, and the second vehicle is not at the safe distance from the road edge, the action control module 120 may decide 218 to stop the first vehicle or the second vehicle.

If the first vehicle is not at the safe distance from the road edge, or the second vehicle is at the safe distance from the road edge, the action control module 120 may check 212 whether a leeway distance is greater than the safe distance from the one or more vehicles that are in proximity or the road edge. If the leeway distance is greater than the safe distance from the one or more vehicles that are in proximity or the road edge, the action control module 120 may transmit 214, to the second vehicle, the driving instructions to change a driving lane. For example, let ChL be a set of vehicles which are advised to steer left (subset ChL_L) or right (subset ChL_R) based on their current path of travel in order to make the gap from the road edges or approaching vehicle safe. Further, ChLF be a function which input ChL set and outputs the required distance to steer left or right as:

$${∀}_{Vi ϵ P ( P X ( V i \pm d ) )} [ CHLF ( {V}_{i} , ( P X ( {V}_{i} \pm d ) ∖ {V}_{i} ) , {U}_{Y} ( P X ( {V}_{i} \pm d ) ) , {D}_{Y} ( P X ( {V}_{i} \pm d ) ) ) = ( ( {d}_{req} = ( {U}_{Y} - ( {μ}_{i j k Y} * S {E}_{d Y} ) ) ) > 0 ) ? {V}_{i} ϵ {ChL}_{L} : [ ( {d}_{req} = ( {D}_{Y} - ( {μ}_{i j k Y} * S {E}_{d Y} ) ) ) > 0 ) ? {V}_{i} ϵ {ChL}_{R} : {V}_{i} ϵ ST ]$$

where d_{req} is a distance required to steer left or right.

When the leeway distance is less than the safe distance from the second vehicle or the road edge or the second vehicle is not at the safe distance from the road edge, the action control module 120 may decide 218 to stop the first vehicle or the second vehicle. For example, let STF be a function such that:

$$\begin{matrix}\{ ∀ {V}_{i} ϵ P ( P X ( {V}_{i} , \pm d ) ) [ S T F ( ( S T ( {V}_{i} ) , ( PX ( {V}_{i} , \pm d ) ∖ {V}_{i} ) , {V}_{s i} , {V}_{α i} , dx ) ) ] \\ = ( ( {Q}_{( i j w ) d x} - {( {V}_{i} )}_{w i} - P {X ( {V}_{i} )}_{w i} - ( 2 * {μ}_{i j k Y} * S {E}_{d Y} ) ) \\ \geq ( {μ}_{i j k Y} * S {E}_{d Y} ) ) ? {V}_{i} ϵ SL : {V}_{i} ϵ STnPK \}\end{matrix}$$

where,
Vₛᵢ is a current speed of vehicle Vᵢ where (i=1, 2 . . . n),
V_{αi} be a current acceleration of the vehicle Vᵢ where (i=1, 2 . . . n),
dₓ be defined as a point which is desired for one of the vehicles to arrive for giving safe passage to another vehicle, if possible,
STnPK be a set of vehicles which are stopped and parked at a nearest available spot, and
ST be a set of vehicles which are advised to stop based on a potential collision or unsafe driving situations when the set of vehicles pass by each other at a particular road point.

Upon deciding 218 to stop the first or second vehicle, the action control module 120 may determine 220 whether there is safe road width distance to stop the first vehicle or the second vehicle. If there is safe road width distance to stop the first vehicle or the second vehicle, the action control module 120 may transmit 222 the driving instructions to slow down the first vehicle or the second vehicle to a safe spot.

For example, let the SL be a set of vehicles which are advised to slow down in order to reach to a safe spot when approaching vehicle can make a safe passage. Thus, SLF be a function which inputs a set SL and outputs a required speed to slow down. In this example, the SLF can be defined as:

$$\{ {∀}_{Vi ϵ P ( PX ( V i \pm d ) )} [ S L F ( ( S L ( {V}_{i} ) , ( PX ( {V}_{i} \pm d ) ∖ {V}_{i} , {V}_{s i} , {V}_{α i} , {d}_{x} , {t}_{x} ) ) ) ] = ( ( 2 * {d}_{x} / {t}_{x} ) - {V}_{s i} ) = {V}_{s x i} ) ? {V}_{i} ϵ OKP : {V}_{i} ϵ ST \}$$

where,
tₓ is defined as a time taken to reach dₓ by an approaching vehicle,
Vₛₓᵢ is a desired speed to reach dₓ in tₓ time,
OKP be a set of vehicles which are advised okay to proceed based on respective proximity hindrance changes, and
dₜ be defined as a spot where vehicles may cross reach other.
   In case of a trailing vehicle, Vₛₓᵢ be a speed at which leading vehicle is driving and SLF can be defined as

$$\{ {∀}_{Vi ϵ P ( P X ( V i \pm d ) )} [ S L F ( ( ( {V}_{i} ) , ( PX ( {V}_{i} \pm d ) ∖ {V}_{i} , {V}_{s i} , {V}_{α i} , {d}_{x} , {t}_{x} ) ) ) ] = ( {V}_{s i} ) = {V}_{s x i} ) ? {V}_{i} ϵ OKP : {V}_{i} ϵ ST \}$$

If the safe road width distance is unavailable to stop the first vehicle or the second vehicle, the action control module 120 may perform 226 a congestion check to determine if there is congestion in road. If there is congestion in road, the action control module 120 may transmit 224 the driving instructions to stop and park the first vehicle or the second vehicle. For example, let STNR be a set of vehicles which are stationary and in transit with Vₛᵢ=0 on route Rtᵢⱼ. Further, SLMT be the set of vehicles which are moving at a certain percentage slower than an average speed at a given stretch of the road for certain time and are in transit with Vₛᵢ< (ηₛₗₘₜ*Vᵢⱼₖ (Qᵢⱼᵣₛ)*Tₛₗₘₜ) on route Rtᵢⱼ, where Tₛₗₘₜ is the duration for which a vehicle has been moving at a certain percentage slower than the average speed and ηₛₗₘₜ be a percentage by which vehicle is slower. In this example, let STnPKF(STnPK(Vᵢ, (PX(Vᵢ+d)\Vᵢ)), Qᵢⱼ) be a function such that

$$\begin{matrix}{∀}_{Vi ϵ P ( P X ( V i \pm d ) )} [ ( ( {U}_{Y} ( {P}_{1} ) , {D}_{Y} ( {P}_{1} ) ) \geq ( {μ}_{i j k Y} * S {E}_{d Y} ) ) \& \& ( {U}_{X} ( {P}_{1} ) , {D}_{X} ( {P}_{1} ) ) \\ \geq ( {μ}_{i j k X} * S {E}_{d X} ) ? {P}_{1} ϵ PSS : ( {U}_{Y} ( {V}_{i} ) , {D}_{Y} ( P {V}_{i} ) ) \\ \geq ( {μ}_{i j k Y} * S {E}_{d Y} ) \& \& ( {U}_{X} ( {V}_{i} ) , {D}_{X} ( {V}_{i} ) ) \geq ( {μ}_{i j k X} * S {E}_{d X} ) ? {V}_{i} ϵ OKP : {V}_{i} ϵ STnPK ]\end{matrix}$$

Also, for every Vᵢ, the action control module 120 checks congestion and stop the first or second vehicle from approaching in case of following:

$$\begin{matrix}\{ {∀}_{( Vi ϵ T ( Rtij ) )} [ ( count ( STNR \backslash ( ( STnPK ) ⋃ ST ) ) > N ) OR ( count ( SLMT \backslash SL ) \\ > M ) ? {V}_{i} ϵ STnPK : {V}_{i} ϵ OKP ] \}\end{matrix}$$

where N and M are a number of vehicles that can be configured to trigger a congestion alert.

Further, if the first vehicle is not at a safe distance from the one or more vehicles that are in proximity or upon transmitting the driving instructions to the second vehicle to change the driving lane, or upon transmitting the driving instructions to the first or second vehicle to slow down, or upon determining no congestion in the road, the action control module 120 may determine 216 whether the driving instructions are transmitted to the plurality of vehicles. If the driving instructions are not transmitted to one or more of the plurality of vehicles, the action control module 120 may reiterate the process flow 200 for the one or more of the plurality of vehicles. If the driving instructions are transmitted to the plurality of vehicles, for example, the first and second vehicles, the action control module 120 checks if the transmitted driving instructions are ok to proceed. If the transmitted driving instructions are ok to proceed 228, the action control module 120 allows 232 the respective plurality of vehicles to arrive at an intended destination. For example, for every Vᵢ, the action control module 120 suggest action or the driving instructions as following:

$$\{ {∀}_{( Vi ϵ T ( Rtij ) )} [ ( count ( STNR \backslash ( ( STnPK ) ⋃ ST ) ) > N ) OR ( count ( SLMT \backslash SL ) > M ) ? {V}_{i} ϵ STnPK : \{ {∀}_{Vi ϵ P ( P X ( V i \pm d ) )} [ ( ( ( {U}_{Y} ( {P}_{1} ) , {D}_{Y} ( {P}_{1} ) ) \geq ( {μ}_{i j k Y} * S {E}_{d Y} ) ) \&\& ( {U}_{X} ( {P}_{1} ) , {D}_{X} ( {P}_{1} ) ) \geq ( {μ}_{i j k X} * S {E}_{d X} ) ? {P}_{1} ϵ PSS : [ ( {D}_{Y} ( {P}_{i} ) \geq ( {μ}_{i j k Y} * S {E}_{d Y} ) ) ? [ ( {U}_{Y} ( {P}_{i} ) \geq ( {μ}_{i j k Y} * S {E}_{d Y} ) ) ? {P}_{1} ϵ PSS : [ ( {Q}_{( ijw ) dt} - {( {P}_{i} )}_{wi} - {( {P}_{1} )}_{w 1} - ( 2 * {μ}_{i j k Y} * S {E}_{d Y} ) > ( {μ}_{i j k Y} * S {E}_{d Y} ) ) ? ( {P}_{i} ϵ ChLF ( ChL ) \&\& {P}_{1} ϵ ChLF ( ChL ) ) : {P}_{i} ϵ STF ( ST ) ] ] : [ ( {Q}_{( ijw ) dt} - {( {P}_{i} )}_{wi} - {( {P}_{1} )}_{w 1} - ( 2 * {μ}_{i j k Y} * S {E}_{d Y} ) > ( {μ}_{i j k Y} * S {E}_{d Y} ) ) ? ( {P}_{i} ϵ ChLF ( ChL ) \&\& {P}_{1} ϵ ChLF ( ChL ) ) : {P}_{i} ϵ STF ( ST ) ] ] \&\& [ ( {D}_{X} ( {P}_{i} ) \geq ( {μ}_{ijkX} * S {E}_{dX} ) ) ? [ ( {U}_{X} ( {P}_{i} ) \geq ( {μ}_{ijkX} * S {E}_{dX} ) ) ? {P}_{i} ϵ OKP : {P}_{i} ϵ STF ( S T ) ] : {P}_{i} ϵ SLF ( SL ) ] ] \} ] \}$$

Where, i=2, . . . ,n,
PSS be a set of vehicles which are advised to pass, and
OKP be a set of vehicles which are advised okay to proceed based on their proximity hindrance changes.

In an example, the action control module 120 may continuously check a status of vehicle proximity changes until d=0. For example, at 200 m, another approaching vehicle is detected and the action control module 120 generates a response to pass, however the action control module 120 runs again at 190 m (at every decrement of 10 m) and the action control module 120 generates responses based on the status of the vehicle proximity.

If the transmitted driving instructions are not ok to proceed, the action control module 120 may then reassign 230 the priority of the plurality of vehicles and repeat the process flow 200. For example, after first drop, there may be a reassignment of the vehicles from the drop site to the work site and back based on the wait time at the equipment or the drop site. Let VMᵣₑ be a function such that for each fit vehicle available gets mapped to each fit equipment available at its work site to pick the material assigned. In this example, a fit vehicle V₁ may be assigned to a fit equipment E₁ to pick material M₁ in a shift Sh₁ from WS₁ to DP₁ while returning but function,

$$V {M}_{re} ( ( M ( {m}_{1} ) , {WS}_{k} , {DP}_{1} , S ( F ( {V}_{i} ) , R ( H ( {E}_{j} ) ) ) ) ) = \{ V {M}_{re 1} i . e . , ( {m}_{1} , {WS}_{2} , {DP}_{1} , {V}_{1} , {E}_{2} ) \}$$

where (i, j, k=1,2 . . . n),
In this example, if there are no available equipment, the function VMᵣₑ may return a null value and Vᵢ may remain part of set F(Vᵢ) and wait for assignment at the drop site.

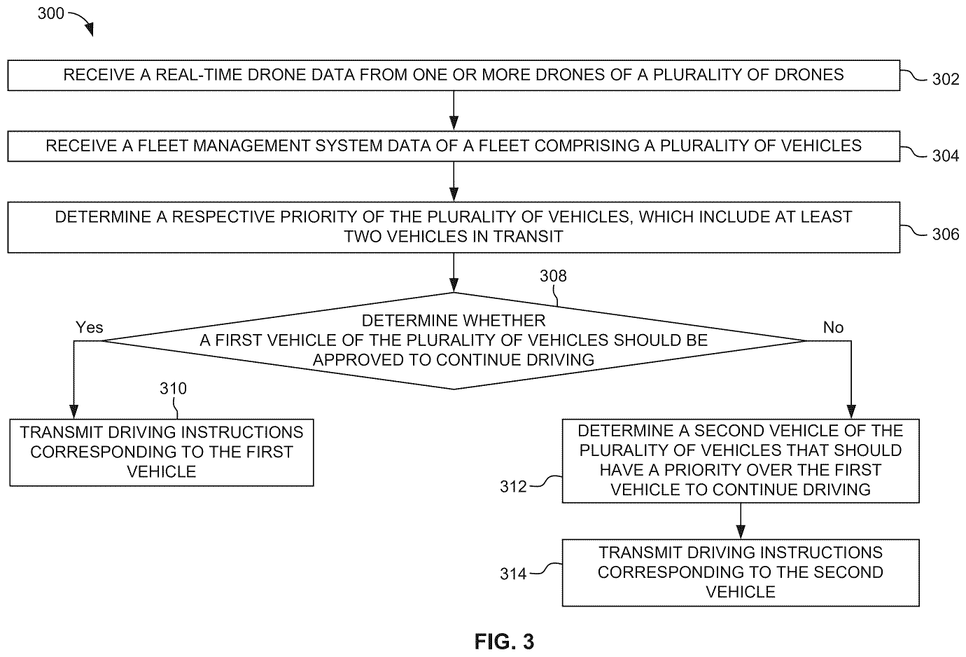

FIG. 3 is a flow diagram that presents an example computer implemented method 300 for drone-guided traffic assistance, in accordance with implementations of the present disclosure. In some implementations, the method 300 may be executed by the processor 128 or a processor 402 (including the one or more processors), as described in relation to FIG. 1-2, or 4.

The method 300 includes receiving 302 real-time drone data from one or more drones of a plurality of drones. The real-time drone data is based on one or more image sensors positioned at the one or more drones of the plurality of drones. For example, the real-time drone data may include elevation information of a route of each vehicle of the plurality of vehicles, vehicle location information within a predetermined proximity threshold information for each vehicle, and/or payload data information of each vehicle.

Further, the method 300 may include receiving 304 fleet management system data of a fleet comprising a plurality of vehicles. For example, the fleet management system data may include route information for each vehicle of the plurality of vehicles, a type of payload being carried by each vehicle of the plurality of vehicles, and/or a schedule for each vehicle of the plurality of vehicles. Based on the real-time drone data and the fleet management system data, the method 300 may include determining 306 a respective priority of the plurality of vehicles, which include at least two vehicles in transit.

Furthermore, based on the real-time drone data and the fleet management system data, the method 300 may include determining 308 whether a first vehicle of the plurality of vehicles should be approved to continue driving. In an example, the method 300 may include determining whether the first vehicle is at least a safe threshold distance away from one or more vehicles of the plurality of vehicles. Further, the method may include determining whether the first vehicle is at least a safe edge distance away.

Also, the method 300 may include transmitting 310, to the first vehicle, driving instructions corresponding to the first vehicle based upon determining that the first vehicle should be approved to continue driving. In an example, the method 300 may include transmitting, to the first vehicle, the driving instructions corresponding to the first vehicle to continue driving based upon determining that the first vehicle is at least the safe threshold distance away from one or more vehicles of the plurality of vehicles and based upon determining that the first vehicle is at least the safe edge distance away. In another example, the method 300 may include transmitting, to the first vehicle, based upon determining that the first vehicle is at least the safe threshold distance away from one or more vehicles of the plurality of vehicles and based upon determining that the first vehicle is not at least the safe edge distance away, the driving instructions corresponding to the first vehicle to change a driving lane and continue driving in a new driving lane if a leeway distance is at least greater than the safe threshold distance. In yet another example, the method 300 may include transmitting, to the first vehicle, based upon determining that the first vehicle is not at least the safe threshold distance away from one or more vehicles of the plurality of vehicles and based upon determining that the first vehicle is at least the safe edge distance away, the driving instructions corresponding to the first vehicle to change a driving lane and continue driving in a new driving lane if a leeway distance is at least greater than the safe edge distance. In another example, the method 300 may include transmitting, to the first vehicle, based upon determining that the first vehicle is not at least the safe threshold distance away from one or more vehicles of the plurality of vehicles and based upon determining that the first vehicle is not at least the safe edge distance away, the driving instructions corresponding to the first vehicle to stop to determine whether the one or more vehicles of the plurality of vehicles should be prioritized for driving instead of the first vehicle. For example, the driving instructions corresponding to the first vehicle to stop is further transmitted based upon a road width and traffic congestion on a route of the first vehicle.

Also, the method 300 may include determining 312 a second vehicle of the plurality of vehicles that should have a priority over the first vehicle to continue driving based upon determining that the first vehicle should not be approved to continue driving. The method 300 may then include transmitting 314, to the second vehicle, driving instructions corresponding to the second vehicle.

Implementations of the present disclosure provide technical solutions to multiple technical problems that arise in the context of traffic assistance. The proposed methodology optimizes on-surface mining fleet and equipment productivity and utilization by combining real time drone-based movement, terrain and location data with existing site maps data, vehicle and equipment schedule data and on-board vehicle sensor data to suggest near-real time driving instructions. Thus, the proposed methodology reduces blockages and accidents resulting into lower operational costs, reduced time, higher sustainability, optimal equipment usage and improved safety. Further, the proposed methodology provides real time visibility of dynamically changing surface, vehicle conditions and weather conditions beyond visual and/or on-vehicle sensor line-of-sight by using drones to provide traffic instructions or recommendations for higher precisions.

Further, based on historical data on actual performance, driving behavior, trip time, harsh incidents, and/or the like, the proposed methodology uses in-built AI or ML algorithms to measure compliance and performance impacts for suggesting better action or instruction in future scenarios.

Furthermore, the proposed methodology performs drone-guided dynamic precision decision-making and traffic guidance that can help avoid collisions and improve overall productivity. Therefore, the proposed methodology improves sustainability due to lower wear and tear and optimizes fuel consumption. Also, the proposed methodology can support both autonomous vehicles to take driving decisions as well as recommend actions to drivers with advanced driver assist systems.

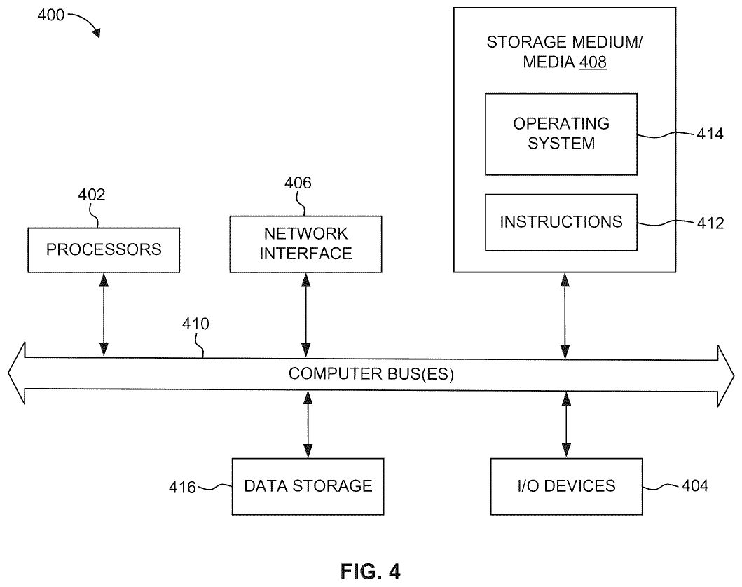

FIG. 4 depicts a computer system 400 that may be used to implement the system 112 of FIG. 1, in accordance with implementations of the present disclosure. More particularly, computing machines such as desktops, laptops, smartphones, tablets, and wearables which may be used to provide drone-guided traffic assistance. The computer system 400 may include additional components not shown and that some of the process components described may be removed and/or modified. In another example, a computer system 400 may be deployed on external-cloud platforms such as cloud, internal corporate cloud computing clusters, organizational computing resources, and/or the like.

The computer system 400 includes processor(s) 402, such as a central processing unit, ASIC or another type of processing circuit, input/output devices 404, such as a display, mouse keyboard, and the like a network interface 406, such as a Local Area Network (LAN), a wireless 802.11x LAN, a 3G or 4G mobile WAN or a WiMax WAN, and a computer-readable medium 408. Each of these components may be operatively coupled to a bus 410. The computer-readable medium 408 may be any suitable medium that participates in providing instructions to the processor(s) 402 for execution. For example, the computer-readable medium 408 may be non-transitory or non-volatile medium, such as a magnetic disk or solid-state non-volatile memory or volatile medium such as RAM. The instructions or modules stored on the computer-readable medium 408 may include machine-readable instructions 412 executed by the processor(s) 402 that cause the processor(s) 402 to perform the methods and functions of the system 112.

The system 112 may be implemented as software stored on a non-transitory processor-readable medium and executed by the processor(s) 402. For example, the computer-readable medium 408 may store an operating system 414, such as MAC OS, MS WINDOWS, UNIX, or LINUX, and code, for the system 112. The operating system 414 may be multi-user, multiprocessing, multitasking, multithreading, real-time, and the like. For example, during runtime, the operating system 414 is running and the code for the system 112 is executed by the processor(s) 402.

The computer system 400 may include a data storage 416, which may include non-volatile data storage. The data storage 416 stores any data used or generated by the system 112.

The network interface 406 connects the computer system 400 to internal systems for example, via a LAN. Also, the network interface 406 may connect the computer system 400 to the Internet. For example, the computer system 400 may connect to web browsers and other external applications and systems via the network interface 406.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 402 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for drone-guided traffic assistance, the computer-implemented method comprising:
receiving real-time drone data from one or more drones of a plurality of drones;
receiving fleet management system data of a fleet comprising a plurality of vehicles;
determining, based on the real-time drone data and the fleet management system data, a respective priority of the plurality of vehicles, which include at least two vehicles in transit;
determining, based on the real-time drone data and the fleet management system data, whether a first vehicle of the plurality of vehicles should be approved to continue driving;
transmitting, based upon determining that the first vehicle should be approved to continue driving, to the first vehicle, driving instructions corresponding to the first vehicle;
determining, based upon determining that the first vehicle should not be approved to continue driving, a second vehicle of the plurality of vehicles that should have a priority over the first vehicle to continue driving; and
transmitting, to the second vehicle, driving instructions corresponding to the second vehicle.

2. The computer-implemented method of claim 1, wherein:
the real-time drone data is based on one or more image sensors positioned at the one or more drones of the plurality of drones,
the real-time drone data comprises elevation information of a route of each vehicle of the plurality of vehicles, vehicle location information within a predetermined proximity threshold information for each vehicle of the plurality of vehicles, and/or payload data information of each vehicle of the plurality of vehicles, and
the fleet management system data comprises route information for each vehicle of the plurality of vehicles, a type of payload being carried by each vehicle of the plurality of vehicles, and/or a schedule for each vehicle of the plurality of vehicles.

3. The computer-implemented method of claim 1, wherein determining whether the first vehicle should be approved to continue driving comprises:
determining whether the first vehicle is at least a safe threshold distance away from one or more vehicles of the plurality of vehicles; and
determining whether the first vehicle is at least a safe edge distance away.

4. The computer-implemented method of claim 3, wherein transmitting, to the first vehicle, the driving instructions corresponding to the first vehicle comprises:
transmitting, to the first vehicle, based upon determining that the first vehicle is at least the safe threshold distance away from one or more vehicles of the plurality of vehicles and based upon determining that the first vehicle is at least the safe edge distance away, the driving instructions corresponding to the first vehicle to continue driving in a same driving lane.

5. The computer-implemented method of claim 3, wherein transmitting, to the first vehicle, the driving instructions corresponding to the first vehicle comprises:
transmitting, to the first vehicle, based upon determining that the first vehicle is at least the safe threshold distance away from one or more vehicles of the plurality of vehicles and based upon determining that the first vehicle is not at least the safe edge distance away, the driving instructions corresponding to the first vehicle to change a driving lane and continue driving in a new driving lane if a leeway distance is at least greater than the safe threshold distance.

6. The computer-implemented method of claim 3, wherein transmitting, to the first vehicle, the driving instructions corresponding to the first vehicle comprises:
transmitting, to the first vehicle, based upon determining that the first vehicle is not at least the safe threshold distance away from one or more vehicles of the plurality of vehicles and based upon determining that the first vehicle is at least the safe edge distance away, the driving instructions corresponding to the first vehicle to change a driving lane and continue driving in a new driving lane if a leeway distance is at least greater than the safe edge distance.

7. The computer-implemented method of claim 3, further comprising:
transmitting, to the first vehicle, based upon determining that the first vehicle is not at least the safe threshold distance away from one or more vehicles of the plurality of vehicles and based upon determining that the first vehicle is not at least the safe edge distance away, the driving instructions corresponding to the first vehicle to stop to determine whether the one or more vehicles of the plurality of vehicles should be prioritized for driving instead of the first vehicle.

8. The computer-implemented method of claim 7, wherein transmitting the driving instructions corresponding to the first vehicle to stop is further based upon a road width and traffic congestion on a route of the first vehicle.

9. A system for drone-guided traffic assistance, the system comprising:
at least one memory configured to store machine executable instructions; and
at least one processor communicatively coupled with the at least one memory, and configured to execute the machine executable instructions to perform operations comprising:
receiving real-time drone data from one or more drones of a plurality of drones;
receiving fleet management system data of a fleet comprising a plurality of vehicles;
determining, based on the real-time drone data and the fleet management system data, a respective priority of the plurality of vehicles, which include at least two vehicles in transit;
determining, based on the real-time drone data and the fleet management system data, whether a first vehicle of the plurality of vehicles should be approved to continue driving;
transmitting, based upon determining that the first vehicle should be approved to continue driving, to the first vehicle, driving instructions corresponding to the first vehicle;
determining, based upon determining that the first vehicle should not be approved to continue driving, a second vehicle of the plurality of vehicles that should have a priority over the first vehicle to continue driving; and
transmitting, to the second vehicle, driving instructions corresponding to the second vehicle.

10. The system of claim 9, wherein:
the real-time drone data is based on one or more image sensors positioned at the one or more drones of the plurality of drones,
the real-time drone data comprises elevation information of a route of each vehicle of the plurality of vehicles, vehicle location information within a predetermined proximity threshold information for each vehicle of the plurality of vehicles, and/or payload data information of each vehicle of the plurality of vehicles, and
the fleet management system data comprises route information for each vehicle of the plurality of vehicles, a type of payload being carried by each vehicle of the plurality of vehicles, and/or a schedule for each vehicle of the plurality of vehicles.

11. The system of claim 9, wherein determining whether the first vehicle should be approved to continue driving comprises:
determining whether the first vehicle is at least a safe threshold distance away from one or more vehicles of the plurality of vehicles; and
determining whether the first vehicle is at least a safe edge distance away.

12. The system of claim 11, wherein transmitting, to the first vehicle, the driving instructions corresponding to the first vehicle comprises:
transmitting, to the first vehicle, based upon determining that the first vehicle is at least the safe threshold distance away from one or more vehicles of the plurality of vehicles and based upon determining that the first vehicle is at least the safe edge distance away, the driving instructions corresponding to the first vehicle to continue driving.

13. The system of claim 11, wherein transmitting, to the first vehicle, the driving instructions corresponding to the first vehicle comprises:
transmitting, to the first vehicle, based upon determining that the first vehicle is at least the safe threshold distance away from one or more vehicles of the plurality of vehicles and based upon determining that the first vehicle is not at least the safe edge distance away, the driving instructions corresponding to the first vehicle to change a driving lane and continue driving in a new driving lane if a leeway distance is at least greater than the safe threshold distance.

14. The system of claim 11, wherein transmitting, to the first vehicle, the driving instructions corresponding to the first vehicle comprises:
transmitting, to the first vehicle, based upon determining that the first vehicle is not at least the safe threshold distance away from one or more vehicles of the plurality of vehicles and based upon determining that the first vehicle is at least the safe edge distance away, the driving instructions corresponding to the first vehicle to change a driving lane and continue driving in a new driving lane if a leeway distance is at least greater than the safe edge distance.

15. The system of claim 11, further comprising:
transmitting, to the first vehicle, based upon determining that the first vehicle is not at least the safe threshold distance away from one or more vehicles of the plurality of vehicles and based upon determining that the first vehicle is not at least the safe edge distance away, the driving instructions corresponding to the first vehicle to stop to determine whether the one or more vehicles of the plurality of vehicles should be prioritized for driving instead of the first vehicle.

16. The system of claim 15, wherein transmitting the driving instructions corresponding to the first vehicle to stop is further based upon a road width and traffic congestion on a route of the first vehicle.

17. A non-transitory computer-readable media (CRM) storing instructions thereon, which, when executed by at least one processor of a computing device, cause the computing device to provide drone-guided traffic assistance by performing operations comprising:
receiving real-time drone data from one or more drones of a plurality of drones;
receiving fleet management system data of a fleet comprising a plurality of vehicles;
determining, based on the real-time drone data and the fleet management system data, a respective priority of the plurality of vehicles, which include at least two vehicles in transit;
determining, based on the real-time drone data and the fleet management system data, whether a first vehicle of the plurality of vehicles should be approved to continue driving;
transmitting, based upon determining that the first vehicle should be approved to continue driving, to the first vehicle, driving instructions corresponding to the first vehicle;
determining, based upon determining that the first vehicle should not be approved to continue driving, a second vehicle of the plurality of vehicles that should have a priority over the first vehicle to continue driving; and
transmitting, to the second vehicle, driving instructions corresponding to the second vehicle.

18. The non-transitory CRM of claim 17, wherein:
the real-time drone data is based on one or more image sensors positioned at the one or more drones of the plurality of drones;
the real-time drone data comprises elevation information of a route of each vehicle of the plurality of vehicles, vehicle location information within a predetermined proximity threshold information for each vehicle of the plurality of vehicles, and/or payload data information of each vehicle of the plurality of vehicles; and
the fleet management system data comprises route information for each vehicle of the plurality of vehicles, a type of payload being carried by each vehicle of the plurality of vehicles, and/or a schedule for each vehicle of the plurality of vehicles.

19. The non-transitory CRM of claim 17, wherein determining whether the first vehicle should be approved to continue driving comprises:
determining whether the first vehicle is at least a safe threshold distance away from one or more vehicles of the plurality of vehicles; and
determining whether the first vehicle is at least a safe edge distance away.

20. The non-transitory CRM of claim 19, wherein transmitting, to the first vehicle, the driving instructions corresponding to the first vehicle comprises:
transmitting, to the first vehicle, based upon determining that the first vehicle is at least the safe threshold distance away from one or more vehicles of the plurality of vehicles and based upon determining that the first vehicle is at least the safe edge distance away, the driving instructions corresponding to the first vehicle to continue driving; or
transmitting, to the first vehicle, based upon determining that the first vehicle is at least the safe threshold distance away from one or more vehicles of the plurality of vehicles and based upon determining that the first vehicle is not at least the safe edge distance away, the driving instructions corresponding to the first vehicle to change a driving lane and continue driving in a new driving lane if a leeway distance is at least greater than the safe threshold distance; or
transmitting, to the first vehicle, based upon determining that the first vehicle is not at least the safe threshold distance away from one or more vehicles of the plurality of vehicles and based upon determining that the first vehicle is at least the safe edge distance away, the driving instructions corresponding to the first vehicle to change a driving lane and continue driving in the new driving lane if the leeway distance is at least greater than the safe edge distance; or
transmitting, to the first vehicle, based upon determining that the first vehicle is not at least the safe threshold distance away from one or more vehicles of the plurality of vehicles and based upon determining that the first vehicle is not at least the safe edge distance away, the driving instructions corresponding to the first vehicle to stop to determine whether the one or more vehicles of the plurality of vehicles should be prioritized for driving instead of the first vehicle.
